(19) United States
(12) Patent Application Publication
(10) Pub. No.: US 2022/0321440 A1
(43) Pub. Date: Oct. 6, 2022

(54) Interface Service Function Monitoring Method and System Based on Data Acquisition

(71) Applicants: Gree Electric Appliances, Inc. of Zhuhai, Zhuhai, Guangdong (CN); Leayun Technology Co., Ltd. of Zhuhai, Zhuhai, Guangdong (CN)

(72) Inventors: Duola JIANG, Zhuhai, Guangdong (CN); Dechao SONG, Zhuhai, Guangdong (CN); Jutao JIA, Zhuhai, Guangdong (CN); Weiwei ZHANG, Zhuhai, Guangdong (CN); Zirong HUANG, Zhuhai, Guangdong (CN)

(21) Appl. No.: 17/623,649

(22) PCT Filed: Jun. 30, 2020
(86) PCT No.: PCT/CN2020/099424

§ 371 Date: Dec. 29, 2021

(30) Foreign Application Priority Data
Aug. 12, 2019 (CN) 201910742294.8

(51) Int. Cl. H04L 43/0823; G06F 8/38; G06F 9/451; G06F 11/36

(52) U.S. Cl. CPC H04L 43/0823; G06F 8/38; G06F 9/451; G06F 11/36

(57) ABSTRACT

The present disclosure discloses an interface service function monitoring method and system based on data acquisition. The method includes the following steps: initiating, by a monitoring device, a service function monitoring request for an interface; determining whether the interface makes a response to the monitoring request; in a case that a response is made, determining whether the response content of the interface is expected; in a case that an abnormality occurs, analyzing, according to abnormality information, a cause of the abnormality, forming an abnormality analysis report, storing the abnormality information and the abnormality analysis report to a target server, and sending, by the target server, the abnormality information and the abnormality analysis report to an administrator; and determining, by the administrator, at least one of current service function states of the interface according to a monitoring record and the abnormality analysis report which are stored in the target server.

### CROSS-REFERENCE TO RELATED APPLICATION

The present disclosure claims the priority of Patent Application No. 201910742294.8 filed on Aug. 12, 2019 and entitled “Interface Service Function Monitoring Method and System Based on Data Acquisition”, the disclosure of which is incorporated by reference herein in its entirety as part of the present disclosure.

### TECHNICAL FIELD

The present disclosure belongs to the technical field of network communications, and particularly relates to an interface service function monitoring method and system based on data acquisition.

### BACKGROUND

With the development of a software technology, more and more software provide services for users through platformization. A third party can customize their own services according to interfaces provided by a platform. Therefore, software nowadays often involves interface testing. Interfaces are some pre-defined functions. The purpose is to provide an ability for applications and developers to access a set of routines based on certain software or hardware, without accessing a source code or understanding the details of an internal working mechanism. Interface testing is a test of inputting data to an interface, acquiring a returned result, and analyzing whether the result is expected.

Therefore, for the software industry, data security and data operation stability are very important features. Once there is a fallacy, it is very likely that users will be completely disappointed in products, resulting in loss of reputation, money, and other aspects. Testing of interface services is an important measure to ensure the data reliability and service stability.

In some solutions known to the inventor, the interface service testing on the market is to learn whether a service is still normally operated by means of detecting port occupancy. This interface service testing method cannot meet the demands of a user for the data security and the data operation stability.

### SUMMARY

The technical problem to be solved by the present disclosure is that an existing interface service monitoring method cannot ensure the data security and the data operation stability.

In order to solve the above technical problems, the present disclosure provides an interface service function monitoring method based on data acquisition, including the following steps:

S1, regularly initiating, by a monitoring device, a service function monitoring request for an interface;

S2, determining whether the interface makes a response to the monitoring request, executing S3 in a case that a response is made, and executing S4 in a case that an abnormality occurs;

S3, determining whether a response content of the interface is expected, storing a monitoring record to a target server if yes, and executing S4 in a case that an abnormality occurs;

S4, analyzing a cause of the abnormality according to abnormality information, forming an abnormality analysis report, storing the abnormality information and the abnormality analysis report to the target server, and sending, by the target server, the abnormality information and the abnormality analysis report to an administrator; and

S5, determining, by the administrator, at least one of current service function states of the interface according to the monitoring record and the abnormality analysis report in the target server.

Preferably, the step S1 of initiating, by a monitoring device, a service function monitoring request for an interface includes:

S1.1, setting a particular service function for the interface;

S1.2, regularly initiating, by the monitoring device, a particular function testing request for the interface.

Preferably, the step S2 specifically includes:

S2.1, determining whether the interface makes a response to the monitoring request:

in a case that a response is made, executing S3;

in a case that an abnormality occurs, executing S2.2;

S2.2, recording the number of abnormalities, and determining whether a recorded number of abnormalities reaches a set value:

in a case that no, initiating, by the monitoring device, a temporary service function monitoring request for the interface in real time;

if yes, executing S4.

Preferably, the step S2 specifically includes: S2.1, determining whether the interface makes a response to the monitoring request:

in a case that a response is made, executing S3;

in a case that an abnormality occurs, executing S2.2;

S2.2, recording the number of abnormalities, and determining whether a recorded number of abnormalities reaches a set value:

in a case that no, executing S2.3;

if yes, executing S4;

S2.3, determining whether the time of the occurrence of the abnormality reaches preset time for regularly initiating the service function monitoring request for the interface:

in a case that no, executing S2.4;

if yes, executing S1;

S2.4, initiating, by the monitoring device, a temporary service function monitoring request for the interface in real time, and returning to the step S2.1.

Preferably, the step S3 specifically includes:

S3.1, determining whether the response content of the interface is expected;

if yes, storing the monitoring record;

in a case that an abnormality occurs, executing S3.2;

S3.2, recording the number of abnormalities, and determining whether a recorded number of abnormalities reaches a set value:

in a case that no, executing S3.3;

if yes, executing S4;

S3.3, determining whether the time of the occurrence of the abnormality reaches preset time for initiating the service function monitoring request for the interface:

if yes, re-executing S1;

in a case that no, executing S3.4;

S3.4, initiating, by the monitoring device, a temporary service function monitoring request for the interface in real time, and returning to the step S3.1.

Preferably, the step S4 of analyzing a cause of the abnormality in a case that the abnormality occurs, and forming, according to the cause of the abnormality, an abnormality analysis report specifically includes:

S4.1, acquiring an unexpected response content, comparing the unexpected response content with an expected response content, and determining, according to a comparison result, the cause of the abnormality; and

S4.2, forming the abnormality analysis report according to the cause of the abnormality.

Preferably, in the step 4, the abnormality information and the abnormality analysis report are further stored in the target server, and the target server performs grading processing on the abnormality information according to the abnormality analysis report and sends a processing result to the administrator and a storage module.

Preferably, in the step S4, the abnormality information is at least divided into a first grade error and a second grade error;

in a case that the abnormality information is the first grade error, the target server sends the abnormality information to the administrator by an email or a short message;

in a case that the abnormality information is the second grade error, the target server backs up the abnormality information and a log thereof and sends the abnormality information and the log thereof to the administrator by an email.

The present disclosure further provides an interface service function monitoring system based on data acquisition, including a monitoring device and a target server. The target server is provided with an interface; the monitoring device is in communication connection with the target server and the interface; the monitoring device and the target server complete monitoring of a service state of the interface of the target server according to the above method. Preferably, the system further includes a display device. The display device is in communication connection with the monitoring device. The display device is configured to display the service state of the interface.

Compared with the prior art, one or more embodiments in the above solution have the following advantages or beneficial effects:

In the present disclosure, clearly for a pointed interface service, all functional modules are monitored; and when a service state of a faulty interface is abnormal, the cause of the abnormality is analyzed, and a solution is generated. The method greatly improves the troubleshooting efficiency and improves the service data reliability and operation stability.

Other features and advantages of the present disclosure will be described in the following specification, and partly become obvious from the specification, or understood by implementing the present disclosure. The objectives and other advantages of the present disclosure can be realized and obtained through the structures specifically pointed out in the specification, claims and drawings.

### BRIEF DESCRIPTION OF THE DRAWINCIS

The accompanying drawings are used to provide a further understanding of the present disclosure and constitute a part of this specification to explain the present disclosure together with the embodiments of the present disclosure, and do not constitute restrictions to the present disclosure. In the drawings:

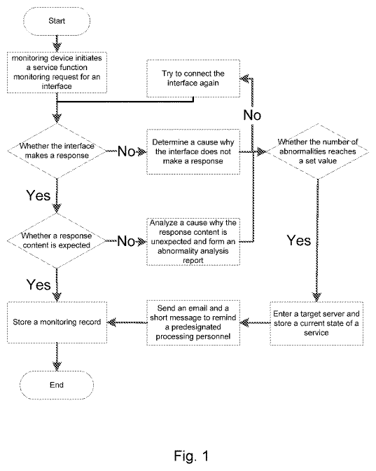

FIG. 1 is a flowchart of an interface service function monitoring method based on data acquisition in the embodiments of the present disclosure;

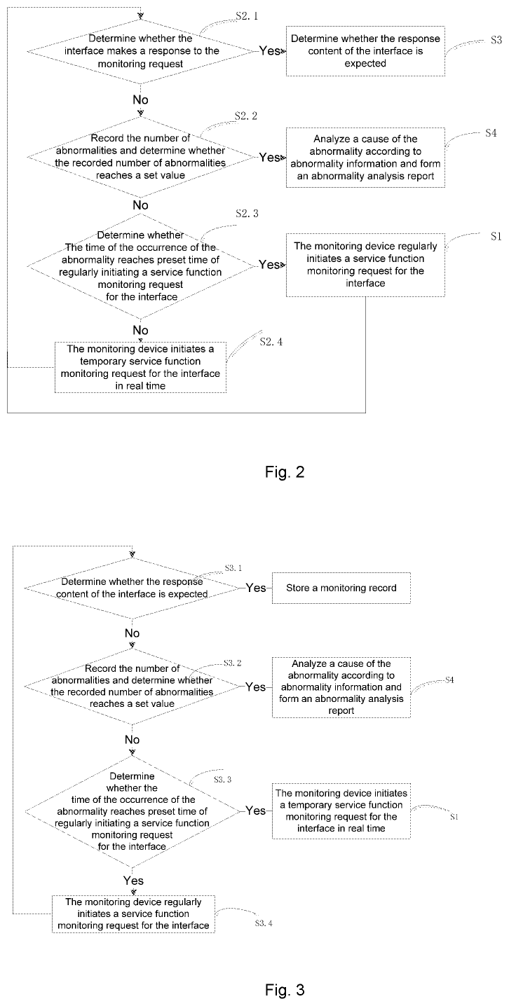

FIG. 2 is a flowchart of a method for determining whether an interface makes a response to a monitoring request in the embodiments of the present disclosure;

FIG. 3 is a flowchart of a method for determining whether the response content of the interface is expected in the embodiments of the present disclosure; and

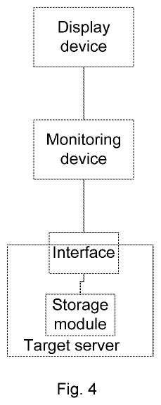

FIG. 4 is a structural diagram of an interface service function monitoring system based on data acquisition in the embodiments of the present disclosure.

### DETAILED DESCRIPTION OF THE EMBODIMENTS

The implementation modes of the present disclosure will be described in detail with the accompanying drawings and embodiments, so as to fully understand and implement an implementation process of how the present invention applies technical means to solve technical problems and achieve technical effects. It should be noted that, each embodiment in the present disclosure and each feature in each embodiment can be combined with each other as long as they do not constitute a conflict, and the technical solutions formed are all within the protection scope of the present disclosure.

The interface service function monitoring based on data acquisition is a very important characteristic to ensure the data security and operation stability of the software industry. Once there is a fallacy, it is very likely that users will be completely disappointed in products, resulting in loss of reputation, money, and other aspects. Monitoring of interface services is an important measure to ensure the data reliability and service stability.

In some solutions known to the inventor, the interface service monitoring on the market can only achieve learning whether an interface service function is still normally operated by means of detecting port occupancy. It is not nearly enough.

### Embodiment I

In order to solve the above technical problems in the prior art, the present disclosure provides an interface service function monitoring method based on data acquisition. Clearly for a pointed interface service, all functional modules are monitored; and in case of a fault, a cause is analyzed and a solution is generated. The problem solving efficiency is greatly improved, and the service data reliability and operation stability are improved.

FIG. 1 illustrates a flowchart of an interface service function monitoring method of the present disclosure. Referring to FIG. 1, the interface service function monitoring method based on data acquisition in the present embodiment includes the following steps.

S1, a monitoring device regular initiates a service function monitoring request for an interface, further including:

S1.1, a particular service function is set for the interface;

S1.2, the monitoring device initiates a particular function testing request for the interface.

S2, whether the interface makes a response to the monitoring request is determined; S3 is executed in a case that a response is made; and S4 is executed in a case that an abnormality occurs, specifically including:

S2.1, whether the interface makes a response to the monitoring request is determined:

in a case that a response is made, S3 is executed;

in a case that an abnormality occurs, S2.2 is executed;

S2.2, the number of abnormalities is recorded, and whether a recorded number of abnormalities reaches a set value is determined:

in a case that no, the monitoring device initiates a temporary service function monitoring request for the interface in real time;

if yes, S4 is executed;

S2.3, whether the time of the occurrence of the abnormality reaches preset time for regularly initiating the service function monitoring request for the interface is determined:

in a case that no, S2.4 is executed;

if yes, S1 is executed;

S2.4, the monitoring device initiates a temporary service function monitoring request for the interface in real time, and the step S2.1 is re-executed.

S3, whether a response content of the interface is expected is determined; a monitoring record is stored to a target server if yes; and S4 is executed in a case that an abnormality occurs.

The step S3 specifically includes:

S3.1, whether the response content of the interface is expected is determined;

if yes, the monitoring record is stored;

in a case that an abnormality occurs, S3.2 is executed;

S3.2, the number of abnormalities is recorded, and whether a recorded number of abnormalities reaches a set value is determined:

in a case that no, S3.3 is executed;

if yes, S4 is executed;

S3.3, whether the time of the occurrence of the abnormality reaches preset time for initiating the service function monitoring request for the interface is determined:

if yes, S1 is re-executed;

in a case that no, S3.4 is executed;

S3.4, the monitoring device initiates a temporary service function monitoring request for the interface in real time, and the step S3.1 is re-executed.

S4, a cause of the abnormality is analyzed according to abnormality information; an abnormality analysis report is formed; the abnormality information and the abnormality analysis report are stored to the target server; and the target server further sends the abnormality information and the abnormality analysis report to an administrator.

The specifically step that the cause of the abnormality is analyzed and the solution is determined according to the cause of the abnormality to form the abnormality analysis report specifically includes the following steps:

S4.1, an unexpected response content is acquired and is then compared with an expected response content, and the cause of the abnormality is determined according to a comparison result; and

S4.2, the solution is determined according to the cause of the abnormality.

The abnormality information and a current service state of the interface are stored in the target server, and the target server performs grading processing on the abnormality information according to the current service state of the interface and sends a processing result to the administrator and a storage module.

Further, the abnormality information is at least divided into a first grade error and a second grade error;

in a case that the abnormality information is the first grade error, the target server sends the abnormality information to the administrator by an email or a short message;

in a case that the abnormality information is the second grade error, the target server backs up the abnormality information and a log thereof and sends the abnormality information and the log thereof to the administrator by an email.

S5, the administrator determines at least one of current service function states of the interface according to the monitoring record and the abnormality analysis report in the target server.

### Embodiment II

In order to better illustrate the technical solutions of the present disclosure, the present embodiment further illustrates the interface service function monitoring method based on data acquisition, referring to FIG. 2 and FIG. 3.

In the present disclosure, a monitoring equipment initiates a particular service function testing request for an interface of a target server. The step that a monitoring equipment initiates a service function monitoring request for an interface includes the following specifically steps:

S1.1, a particular service function is set for the interface. It is assumed that the particular service function of the interface of the target server includes music, news, weather, science, etc.

S1.2, the monitoring equipment regular initiates the particular function testing request for the interface. When the interface makes a response to the testing request, it is indicated that a monitoring result is normal. The monitoring equipment further makes a judgment on the response content of the interface, so as to determine whether the response content of the interface is expected. In a case that the interface does not make a response to the testing request, a cause why the interface does not make a response is analyzed, and the cause why no response is made is stored to the target server; and connecting to the interface is tried again.

The monitoring equipment further needs to regular initiates a testing request for the interface, once, for example, every hour. Therefore, the time needs to be determined when connecting to the interface is tried again. In a case that the time when connecting to the interface is tried again does not reach the preset time that the monitoring equipment initiates a testing request for the interface, the interface is directly connected. In a case that the time when connecting to the interface is tried again reaches the preset time that the monitoring equipment initiates a testing request for the interface, the monitoring equipment re-initiates a testing request for the interface.

The monitoring equipment further records the number of interface's failures in making a response. When a recorded number of interface's failures in making a response reaches a set value (such as 3 times), the cause why the interface does not make a response is stored to the target server.

When the interface makes a response, the step S3 is executed. That is, when the interface makes a response to the monitoring request, whether the response content of the interface is expected is determined. In a case that the response content is expected, the monitoring record is stored to the target server.

In a case that the response content is unexpected, for example, in a case that an expected response content is music while an actual response content is news, the step S4 is executed.

In the step S4, a cause why the response content of the interface is unexpected is analyzed by means of the following steps, and a solution is formed for the cause why the response content is unexpected:

S41, an unexpected response content is acquired and is then compared with the expected response content, and the cause of the abnormality is determined according to a comparison result; and

S42, the solution is determined according to the cause of the abnormality.

It should be noted that in a case that the response content of the interface is an expected abnormal state, the cause why the response content of the interface is unexpected is analyzed, the solution is determined according to the cause of unexpectation, and whether the time of the occurrence of the abnormal state reaches the preset time of initiating the service function monitoring request for the interface is determined. If yes, the monitoring equipment re-initiates a service function monitoring request for the interface, and the monitoring equipment records the number of abnormal states. In a case that no, connecting to the interface is tried again, and the number of record abnormalities is recorded. When the number of record abnormalities reaches a set value, the abnormality information is stored to the target server, and the target server sends the abnormality information to the administrator.

The abnormality information and a current service state of the interface are stored in the target server, and the target server performs grading processing on the abnormality information according to the current service state of the interface and sends a processing result to the administrator.

The abnormality information is at least divided into a first grade error and a second grade error.

Further, in a case that the abnormality information is the first grade error, the target server sends the abnormality information to the administrator by an email or a short message.

It should be noted that the first grade error is a logic error. In case of the first grade error, the target server sends the abnormality information to the administrator by an email or a short message, so as to remind the administrator to timely handle with the abnormality information.

Further, in a case that the abnormality information is the second grade error, the target server backs up the abnormality information and a log thereof and sends the abnormality information and the log thereof to the administrator by an email.

It should be noted that the second grade error is a fatal error such as interruption of the service state of the interface. In case of the second grade error, the target server backs up the abnormality information and the log thereof and sends the abnormality information and the log thereof as well as the solution to the administrator by an urgent mail, so as to remind the administrator to timely handle with the abnormality information. In a case that the administrator does not make a response immediately, the target server continuously repeatedly sends an email to the administrator till the administrator handles with the abnormality information.

The administrator looks up the monitoring record according to a testing page of the monitoring equipment and monitors a service function state of the interface according to the record, so as to timely handle with service function abnormalities of the interface.

According to actual business needs, the above embodiments develop functional testing service distinguishing functions for specifically services, perform domain-relevant skill tests, perform functional tests on interfaces regularly, analyze error causes when errors occur, generate reports and send them to processing staff, back up data to the server timely to avoid data loss, so as to improve the interface service optimization efficiency and ensure the regular operation of interface services, which greatly improves the problem solving efficiency while improving the service data reliability and operation stability.

### Embodiment III

The present embodiment further illustrates an interface service function monitoring system based on data acquisition, so as to better understand the interface service function monitoring method based on data acquisition of the present disclosure.

Referring to FIG. 4, the interface service function monitoring system based on data acquisition includes a monitoring device and a server. The server is provided with an interface; the monitoring device is in communication connection with the server and the interface; and the monitoring device is configured to test a service state of the interface.

The monitoring device initiates a monitoring request for a service function of the interface. In a case that the interface makes a response to the monitoring request, whether the response content is expected is determined. In a case that the interface does not make a response to the monitoring request, the monitoring device analyzes a cause why the interface does not make a response and stores the cause why the interface does not make a response to a target server. Connection is then tried again till the number of interface's failures in making a response reaches a set value.

In a case that the response content of the interface is unexpected, the monitoring device analyzes a cause why the response content of the interface is unexpected, forms an abnormality solution, and stores the cause of the abnormality and the abnormality solution to the target server, and the target server further sends the cause of the abnormality and the abnormality solution to the administrator by an email or a short message, so as to remind the administrator to handle with the abnormality information in time.

The interface service function monitoring system based on data acquisition further includes a display device. The administrator monitors the service state of the interface according to a log displayed by the display device.

In the present disclosure, by means of the above embodiments, clearly for a pointed interface service, all functional modules are monitored; and when the service state of a faulty interface is abnormal, the cause of the abnormality is analyzed, and a solution is generated. The method greatly improves the problem solving efficiency and improves the service data reliability and operation stability.

Although the implementation modes disclosed in the present disclosure are as described above, the content described is only the implementation mode adopted to facilitate the understanding of the present disclosure, and is not intended to limit the present disclosure. Any person skilled in the art of the present disclosure can make any modifications and changes to the form and details of the implementation without departing from the spirit and scope of the present disclosure. However, the protection scope of the present disclosure shall be based on the scope defined by the appended claims.

What is claimed is:

1. An interface service function monitoring method based on data acquisition, comprising:
S1, regularly initiating, by a monitoring device, a service function monitoring request for an interface;
S2, determining whether the interface makes a response to the monitoring request, executing S3 in a case that a response is made, and executing S4 in a case that an abnormality occurs;
S3, determining whether a response content of the interface is expected, storing a monitoring record to a target server in a case that the response content of the interface is expected, and executing S4 in a case that an abnormality occurs;
S4, analyzing a cause of the abnormality according to abnormality information, forming an abnormality analysis report according to the cause of the abnormality, storing the abnormality information and the abnormality analysis report to the target server, and sending, by the target server, the abnormality information and the abnormality analysis report to an administrator so that the administrator determines at least one of current states of the service function of the interface according to the monitoring record and the abnormality analysis report.

2. The monitoring method according to claim 1, wherein S1 of initiating, by the monitoring device, the service function monitoring request for the interface comprises:
S1.1, setting a particular service function for the interface;
S1.2, initiating, by the monitoring device, a particular function testing request for the interface.

3. The monitoring method according to claim 1, wherein S2 specifically comprises:
S2.1, determining whether the interface makes the response to the monitoring request:
in a case that the response is made, executing S3;
in a case that the abnormality occurs, executing S2.2;
S2.2, recording the number of abnormalities, and determining whether a recorded number of abnormalities reaches a set value:
in a case that the recorded number of abnormalities not reach the set value, executing S2.3;
in a case that the recorded number of abnormalities reaches the set value, executing S4;
S2.3, initiating, by the monitoring device, a temporary service function monitoring request for the interface in real time, and returning to the step S2.1.

4. The monitoring method according to claim 1, wherein S2 specifically comprises:
S2.1, determining whether the interface makes a response to the monitoring request:
in a case that the response is made, executing S3;
in a case that the abnormality occurs, executing S2.2;
S2.2, recording the number of abnormalities, and determining whether a recorded number of abnormalities reaches a set value:
in a case that a recorded number of abnormalities not reach the set value, executing S2.3;
in a case that the recorded number of abnormalities reaches the set value executing S4;
S2.3, determining whether a time of an occurrence of the abnormality reaches the preset time for regularly initiating the service function monitoring request for the interface:
in a case that the time of the occurrence of the abnormality not reach the preset time, executing S2.4;
in a case that the time of the occurrence of the abnormality reaches the preset time, executing S1;
S2.4, initiating, by the monitoring device, a temporary service function monitoring request for the interface in real time, and returning to the step S2.1.

5. The monitoring method according to claim 1, wherein S3 specifically comprises:
S3.1, determining whether the response content of the interface is expected;
in a case that the response content of the interface is expected, storing the monitoring record;
in a case that the abnormality occurs, executing S3.2;
S3.2, recording the number of abnormalities, and determining whether a recorded number of abnormalities reaches a set value:
in a case that the recorded number of abnormalities not reach the set value, executing S3.3;
in a case that the recorded number of abnormalities reaches a set value, executing S4;
S3.3, determining whether a time of an occurrence of the abnormality reaches the preset time for initiating the service function monitoring request for the interface:
in a case that the time of the occurrence of the abnormality reaches the preset time, re-executing S1;
in a case that the time of the occurrence of the abnormality not reach the preset time, executing S3.4;
S3.4, initiating, by the monitoring device, a temporary service function monitoring request for the interface in real time, and returning to the step S3.1.

6. The monitoring method according to claim 1, wherein the step S4 of analyzing a cause of the abnormality in a case that the abnormality occurs, and forming, according to the cause of the abnormality, the abnormality analysis report specifically comprises:
S4.1, acquiring an unexpected response content, comparing the unexpected response content with an expected response content, and determining, according to a comparison result, the cause of the abnormality; and
S4.2, forming the abnormality analysis report according to the cause of the abnormality.

7. The monitoring method according to claim 1, wherein the method further comprises: after storing the abnormality information and the abnormality analysis report in the target server, performing, by the target server, grading processing on the abnormality information according to a current service state of the interface, and sending a processing result to the administrator.

8. The monitoring method according to claim 7, wherein in S4, the abnormality information is at least divided into a first grade error and a second grade error;
in a case that the abnormality information is the first grade error, the target server sends the abnormality information to the administrator by an email or a short message;
in a case that the abnormality information is the second grade error, the target server backs up the abnormality information and a log thereof and sends the abnormality information and the log thereof to the administrator by an email.

9. An interface service function monitoring system based on data acquisition, comprising a monitoring device and a target server, wherein the target server is provided with an interface; the monitoring device is in communication connection with the target server and the interface; and the monitoring device and the target server completes monitoring of a service state of the interface of the target server by the method, wherein the method comprises:
S1, regularly initiating, by a monitoring device, a service function monitoring request for an interface;
S2, determining whether the interface makes a response to the monitoring request, executing S3 in a case that a response is made, and executing S4 in a case that an abnormality occurs;
S3, determining whether a response content of the interface is expected, storing a monitoring record to a target server in a case that the response content of the interface is expected, and executing S4 in a case that an abnormality occurs;
S4, analyzing a cause of the abnormality according to abnormality information, forming an abnormality analysis report according to the cause of the abnormality, storing the abnormality information and the abnormality analysis report to the target server, and sending, by the target server, the abnormality information and the abnormality analysis report to an administrator so that the administrator determines at least one of current states of the service function of the interface according to the monitoring record and the abnormality analysis report.

10. The monitoring system according to claim 9, further comprising a display device, wherein the display device is in communication connection with the monitoring device;
and the display device is configured to display the service state of the interface.

11. The monitoring system according to claim 9, wherein S1 of initiating, by the monitoring device, the service function monitoring request for the interface comprises:
S1.1, setting a particular service function for the interface;
S1.2, initiating, by the monitoring device, a particular function testing request for the interface.

12. The monitoring system according to claim 9, wherein S2 specifically comprises:
S2.1, determining whether the interface makes the response to the monitoring request:
in a case that the response is made, executing S3;
in a case that the abnormality occurs, executing S2.2;
S2.2, recording the number of abnormalities, and determining whether a recorded number of abnormalities reaches a set value:
in a case that the recorded number of abnormalities not reach the set value, executing S2.3;
in a case that the recorded number of abnormalities reaches the set value, executing S4;
S2.3, initiating, by the monitoring device, a temporary service function monitoring request for the interface in real time, and returning to the step S2.1.

13. The monitoring system according to claim 9, wherein S2 specifically comprises:
S2.1, determining whether the interface makes a response to the monitoring request:
in a case that the response is made, executing S3;
in a case that the abnormality occurs, executing S2.2;
S2.2, recording the number of abnormalities, and determining whether a recorded number of abnormalities reaches a set value:
in a case that a recorded number of abnormalities not reach the set value, executing S2.3;
in a case that the recorded number of abnormalities reaches the set value executing S4;
S2.3, determining whether a time of an occurrence of the abnormality reaches the preset time for regularly initiating the service function monitoring request for the interface:
in a case that the time of the occurrence of the abnormality not reach the preset time, executing S2.4;
in a case that the time of the occurrence of the abnormality reaches the preset time, executing S1;
S2.4, initiating, by the monitoring device, a temporary service function monitoring request for the interface in real time, and returning to the step S2.1.

14. The monitoring system according to claim 9, wherein S3 specifically comprises:
S3.1, determining whether the response content of the interface is expected;
in a case that the response content of the interface is expected, storing the monitoring record;
in a case that the abnormality occurs, executing S3.2;
S3.2, recording the number of abnormalities, and determining whether a recorded number of abnormalities reaches a set value:
in a case that the recorded number of abnormalities not reach the set value, executing S3.3;
in a case that the recorded number of abnormalities reaches a set value, executing S4;
S3.3, determining whether a time of an occurrence of the abnormality reaches the preset time for initiating the service function monitoring request for the interface:
in a case that the time of the occurrence of the abnormality reaches the preset time, re-executing S1;
in a case that the time of the occurrence of the abnormality not reach the preset time, executing S3.4;
S3.4, initiating, by the monitoring device, a temporary service function monitoring request for the interface in real time, and returning to the step S3.1.

15. The monitoring system according to claim 9, wherein the step S4 of analyzing a cause of the abnormality in a case that the abnormality occurs, and forming, according to the cause of the abnormality, the abnormality analysis report specifically comprises:
S4.1, acquiring an unexpected response content, comparing the unexpected response content with an expected response content, and determining, according to a comparison result, the cause of the abnormality; and
S4.2, forming the abnormality analysis report according to the cause of the abnormality.

16. The monitoring system according to claim 9, wherein the method further comprises: after storing the abnormality information and the abnormality analysis report in the target server, performing, by the target server, grading processing on the abnormality information according to a current service state of the interface, and sending a processing result to the administrator.

17. The monitoring system according to claim 9, wherein in S4, the abnormality information is at least divided into a first grade error and a second grade error;
in a case that the abnormality information is the first grade error, the target server sends the abnormality information to the administrator by an email or a short message;
in a case that the abnormality information is the second grade error, the target server backs up the abnormality information and a log thereof and sends the abnormality information and the log thereof to the administrator by an email.
